(19) United States
(12) Patent Application Publication
(10) Pub. No.: US 2025/0252227 A1
(43) Pub. Date: Aug. 7, 2025

(54) EQUIVALENT HEAT SOURCE MODELING METHOD FOR OSCILLATING LASER WELDING, AND SIMULATION METHOD FOR OSCILLATING LASER WELDING

(71) Applicants: JiangSu XCMG Construction Machinery Research Institute LTD., Jiangsu (CN); XUZHOU XCMG ENVIRONMENT TECHNOLOGY CO., LTD., Jiangsu (CN)

(72) Inventors: Genchen PENG, Jiangsu (CN); Changyu LU, Jiangsu (CN); Zhengyu MENG, Jiangsu (CN); Qinglei HOU, Jiangsu (CN)

(73) Assignees: JiangSu XCMG Construction Machinery Research Institute LTD., Jiangsu (CN); XUZHOU XCMG ENVIRONMENT TECHNOLOGY CO., LTD., Jiangsu (CN)

(21) Appl. No.: 18/280,480

(22) PCT Filed: Apr. 7, 2023
(86) PCT No.: PCT/CN2023/086780

§ 371 Date: Sep. 6, 2023

(30) Foreign Application Priority Data
Oct. 28, 2022 (CN) 202211337825.3

(51) Int. Cl. G06F 30/20; B23K 26/21; B23K 31/00; G06F 119/08

(52) U.S. Cl. CPC G06F 30/20; B23K 26/21; B23K 31/003; G06F 2119/08

(57) ABSTRACT

The invention discloses an equivalent heat source modeling method for oscillating laser welding, comprising: constructing an energy distribution cloud chart of an actual laser welding heat source under different oscillating trajectories, oscillating frequencies and oscillating amplitudes; extracting an energy distribution curve along the center of the heat source, and acquiring spatial position information of multiple target points of interest; constructing an equivalent Gaussian heat source model for each of the target points of interest; and verifying matching degrees between each Gaussian heat source model and the actual laser welding heat source, and taking Gaussian heat source models passing the verification as equivalent heat source models of the actual laser welding heat source. The invention also provides a simulation method for oscillating laser welding, which constructs an equivalent heat source model through the equivalent heat source modeling method, and perform welding simulation based on the equivalent heat source model.

### 1. TECHNICAL FIELD

The invention relates to an equivalent heat source modeling method for oscillating laser welding and a simulation method for oscillating laser welding, and belongs to the technical field of laser welding.

### 2. DESCRIPTION OF RELATED ART

In the welding field, it is difficult to define the welding process and predict post-welding deformation, so computational simulation is introduced to study the welding process by means of numerical simulation to guide the welding process, to realize effective control of welding deformation and defects.

Oscillating laser welding, as welding method emerging in recent years, allows a laser beam to oscillate though the galvanometric technique to change energy distribution of a heat source to improve the welding quality. However, the oscillation of the laser beam makes the welding process more complex and also makes it more difficult to obtain a process window and predict deformation. The simulation technique can solve this problem effectively.

In principle, a surface heat source, a volumetric heat source, and a combinational heat source including a surface heat source and a volumetric heat source all can be used during the simulation process of oscillating laser welding. However, it should be pointed out that, for most heat source models, many parameters have to be introduced for correction to make the heat source models closer to the actual welding process. Although these correction parameters improve the precision of the heat source models, they are not suitable for the oscillating laser welding process, in which the oscillating laser beam requires the coordinates of a heat source to change to some extent with time, so the direct substitution of existing heat source models will greatly prolong the model calculation time, compromising the simulation efficiency; and the addition of an oscillating trajectory makes the whole simulation process more complex, greatly compromising heat source calibration and simulation accuracy.

### BRIEF SUMMARY OF THE INVENTION

To overcome the defects in the prior art, the invention provides an equivalent heat source modeling method for oscillating laser welding and a simulation method for oscillating laser welding to solve the technical problem of long calibration cycle and low calibration accuracy of heat sources during oscillating laser welding simulation in the prior art.

To fulfill the above objective, the invention is implemented through the following technical solution:
In a first aspect, the invention provides an equivalent heat source modeling method for oscillating laser welding, comprising:
Constructing, according to heat source parameters of an actual laser welding heat source to be modeled, an energy distribution cloud chart of the actual laser welding heat source in unit time under different oscillating trajectories, oscillating frequencies, oscillating amplitudes and oscillating speeds;
Extracting, from the energy distribution cloud chart, an energy distribution curve along the center of the heat source;
Selecting multiple target points of interest from the energy distribution curve, and determining spatial position information of the target points of interest;
Constructing a corresponding equivalent Gaussian heat source model for each of the target points of interest according to the spatial position information of the target points of interest and features of the energy distribution curve, and determining a heat source power and a heat source radius of each Gaussian heat source model according to energy distribution of the actual laser welding heat source; and
Verifying matching degrees between each Gaussian heat source model and the actual laser welding heat source, and taking Gaussian heat source models passing the verification as equivalent heat source models of the actual laser welding heat source.

In the first aspect, further, the actual laser welding heat source comprises one or more of a cylinder heat source, a cone heat source, a double-ellipsoid heat source and a surface heat source.

In the first aspect, further, the spatial position information of the target points of interest comprises point coordinates of two positions with a maximum energy density and point coordinates of a position with a minimum energy density in the energy distribution cloud chart.

In the first aspect, further, the heat source parameters comprise a heat source power, a heat source radius and a heat source center.

In the first aspect, further, verifying matching degrees between each Gaussian heat source model and the actual laser welding heat source comprises:
Constructing an energy distribution cloud chart of the Gaussian heat source model, comparing the Gaussian heat source model with the energy distribution cloud chart of the actual laser welding heat source in heat source effective range, point coordinates of positions with a maximum energy density, and point coordinates of positions with a minimum energy density to obtain a cloud chart matching degree;
Substituting the Gaussian heat source model into a welding simulation model to obtain heat field distribution in a welding process, and comparing the heat field distribution with an actual weld cross-sectional appearance to obtain a weld appearance matching degree; and
Determining that the Gaussian heat source model passes the verification only when the cloud chart matching degree and the weld appearance matching degree are both greater than a set matching degree threshold.

In the first aspect, further, the set matching degree threshold is 90%.

In the first aspect, further, the Gaussian heat source models constructed according to the following expression:

$${q}_{i + 1} ( x , y , z ) = {A}_{i + 1} {f}_{i + 1} ( x , y , z )$$

Where, qᵢ₊₁(x,y,z) represents a heat flux density function of an i^{th} Gaussian heat source model, and x, y and z are coordinates of the i^{th} Gaussian heat source model in a space coordinate system, with an X-axis indicating a welding direction, a Y-axis indicating a direction perpendicular to the welding direction, and a Z-axis indicating a welding depth direction; Aᵢ₊₁ represents an energy coefficient of the i^{th} Gaussian heat source model,

$${A}_{i + 1} = \frac{6 {η}_{i + 1} {P}_{i + 1}}{π {r}_{i}^{2} {h}_{i + 1} ( {h}_{i + 1} + {r}_{i} )} ;$$

fᵢ₊₁(x,y,z) represents a shape function of the i^{th} Gaussian heat source model,

$${f}_{i + 1} = exp ( - \frac{3 {r}_{i}^{2}}{{R ( z )}^{2}} ) ;$$

hᵢ₊₁ represents an effective depth of the i^{th} Gaussian heat source model; r_{I} represents the heat source radius of the i^{th} Gaussian heat source model; ηᵢ₊₁ represents an effective power coefficient of the i^{th} Gaussian heat source model; Pᵢ₊₁ represents an actual power of the i^{th} Gaussian heat source model; R(z) represents a heat flux distribution function of the i^{th} Gaussian heat source model.

In a second aspect, the invention provides a simulation method for oscillating laser welding, comprising:
Constructing an equivalent heat source model through the equivalent heat source modeling method in the first aspect; and
Loading a to-be-welded workpiece model, and performing simulated welding on the to-be-welded workpiece model by means of the constructed equivalent heat source model to obtain welding simulation data.

In a third aspect, the invention provides an equivalent heat source modeling device for oscillating laser welding, comprising:
An energy distribution cloud chart construction module configured to construct an energy distribution cloud chart of an actual laser welding heat source to be modeled under different oscillating trajectories, oscillating frequencies and oscillating amplitudes according to heat source parameters of the actual laser welding heat source;
An extraction module configured to extract, from the energy distribution cloud chart, an energy distribution curve along the center of the heat source, select multiple target points of interest from the energy distribution curve, and determine spatial position information of the target points of interest;
An equivalent Gaussian heat source model construction module configured to construct a corresponding equivalent Gaussian heat source model for each of the target points of interest according to the spatial position information of the target points of interest and features of the energy distribution curve, and determine a heat source power and a heat source radius of each Gaussian heat source model according to energy distribution of the actual laser welding heat source; and
A verification module configured to verify matching degrees between each Gaussian heat source model and the actual laser welding heat source, and take Gaussian heat source models passing the verification as equivalent heat source models of the actual laser welding heat source. In a fourth aspect, the invention provides a simulation device for oscillating laser welding, comprising:
A modeling module configured to construct an equivalent heat source model through the equivalent heat source modeling method in the first aspect; and
A welding simulation module configured to load a to-be-welded workpiece model, and perform simulated welding on the to-be-welded workpiece model by means of the constructed equivalent heat source model to obtain welding simulation data.

Compared with the prior art, the invention has the following beneficial effects:
According to the equivalent heat source modeling method for oscillating laser welding provided by the embodiments of the invention, by extracting an energy distribution curve along the center of a heat source from an energy distribution cloud chart, acquiring spatial position information of multiple target points of interest, and coupling the spatial position information of the multiple target points of interest according to features of the energy distribution curve to construct equivalent Gaussian heat source models, energy distribution of the oscillating laser welding heat source is converted into coupled space energy of multiple heat sources, thus simplifying the calculation process, and realizing the construction of high-precision equivalent Gaussian heat source models of the laser welding heat source in different oscillating modes; and the parameters of the equivalent Gaussian heat source models can reach the threshold without repeated adjustment, such that the heat source calibration cycle during oscillating laser welding simulation is greatly shortened, and the overall oscillating laser welding simulation efficiency is improved, accordingly.

### BRIEF DESCRIPTION OF THE SEVERAL VIEWS OF THE DRAWINGS

FIG. 1 illustrates a flow diagram of an equivalent heat source modeling method for oscillating laser welding according to an embodiment of the invention.

FIG. 2 illustrates an energy distribution cloud chart constructed according to heat source parameters of an actual laser welding heat source according to an embodiment of the invention;

FIG. 3 illustrates an energy distribution cloud chart of a Gaussian heat source model constructed through the equivalent heat source modeling method for oscillating laser welding based on the energy distribution cloud chart shown in FIG. 2 according to an embodiment of the invention;

FIG. 4 illustrates a comparison diagram of the welding heat field distribution obtained after a constructed equivalent Gaussian heat source model is substituted into a welding simulation model with an actual weld cross-section according to an embodiment of the invention.

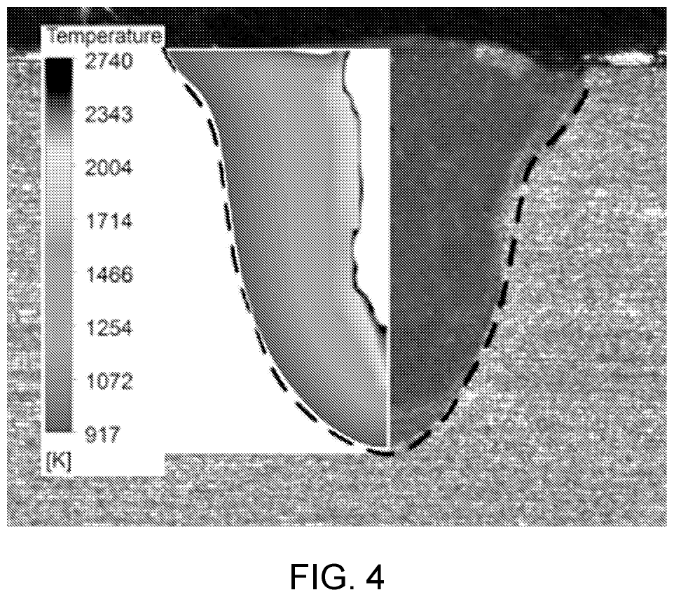

### DETAILED DESCRIPTION OF THE INVENTION

The technical solutions of the invention will be described in detail below with reference to accompanying drawings and specific embodiments. It should be understood that the embodiments of the application and specific features in the embodiments are used for a detailed description of the technical solutions of the application, and are not intended to limit the technical solutions of the application, and the embodiments of the application and the technical features in the embodiments can be combined without conflicts.

### Embodiment 1

It should be noted that an equivalent heat source modeling method for oscillating laser welding provided by this embodiment may be applied to a terminal, which should be configured with a Win7 system or above and a 32/64-bit operating system, support a compiling environment such as a C compiling environment, a LabVIEW compiling environment or a Python compiling environment, and be equipped with a callable mathematical tool such as MATLAB, Python or C. By adopting the equivalent heat source modeling method for oscillating laser welding provided by this embodiment of the invention, high-precision equivalent models of a laser welding heat source can be constructed in different oscillating modes, and the parameters of the equivalent heat source models can reach a threshold without repeated adjustment, such that the calibration cycle of the oscillating laser welding heat source is greatly shortened; and the equivalent heat source modeling method can be used for oscillating laser welding simulation to improve the overall welding simulation efficiency.

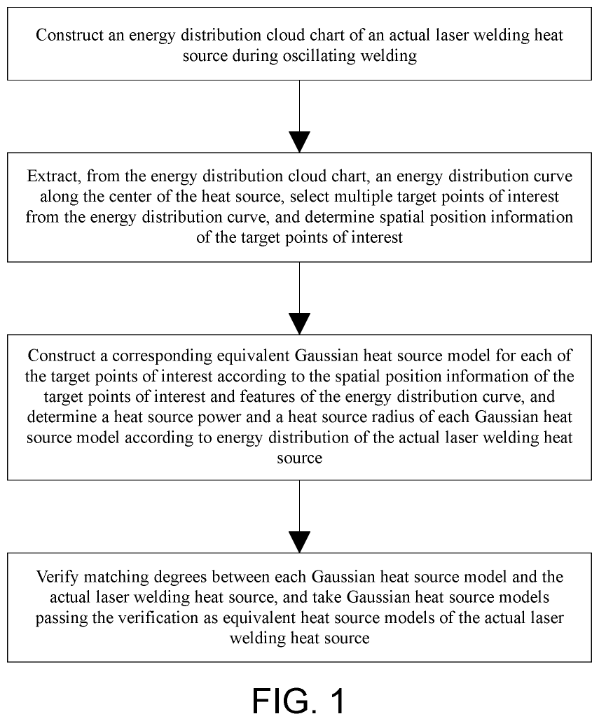

FIG. 1 illustrates a flow diagram of the equivalent heat source modeling method for oscillating laser welding in Embodiment 1 of the invention. The flow diagram merely illustrates a logic order of the method in this embodiment, and in other possible embodiments, the steps shown in or described in the flow diagram can be performed in an order different from the order in FIG. 1, on the premise of no conflicts. Specifically, the equivalent heat source modeling method for oscillating laser welding comprises the following steps:

Step 1: constructing, according to heat source parameters of an actual laser welding heat source to be modeled, an energy distribution cloud chart of the actual laser welding heat source in unit time under different oscillating trajectories, oscillating frequencies, oscillating amplitudes and oscillating speeds;
Wherein, the actual laser welding source may comprise any one or more of a cylinder heat source, a cone heat source, a double-ellipsoid heat source and a surface heat source. The modeling method provided by the embodiment of the invention may adopt two different heat sources, the spatial positions of which are coupled, and the number of the coupled heat sources is not limited, and may be two or more.

In this embodiment of the invention, the energy distribution cloud chart may be constructed through a mathematical tool such as MATLAB/Python, and input parameters include laser power P, heat source radius r, and heat source center Y. In the initial state, the laser welding heat source does not oscillate, and the laser energy distribution on a focusing plane is a standard circular spot, and follows Gaussian normal distribution in the X-axis direction (welding direction) and the Y-axis direction during focusing.

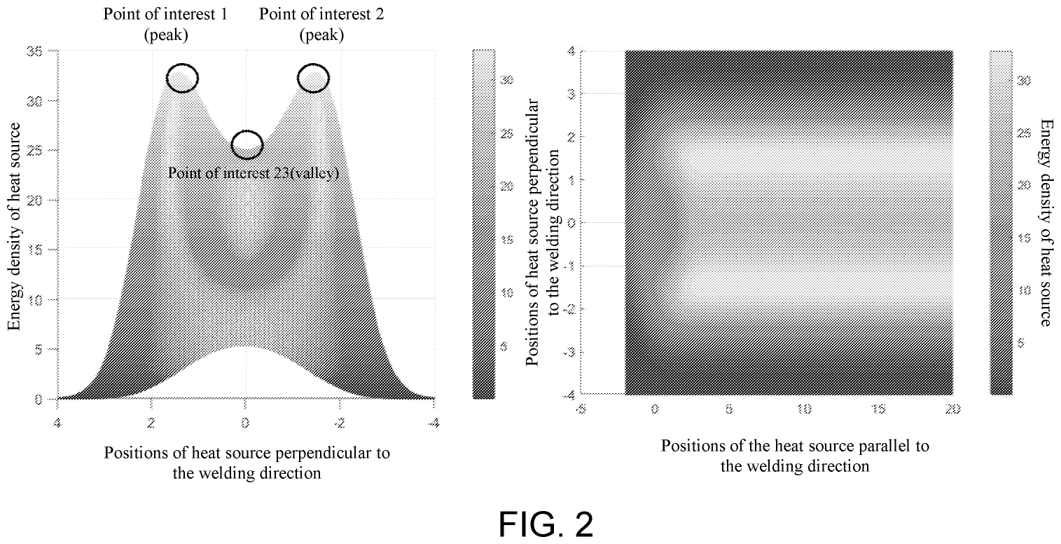

FIG. 2 illustrates an energy distribution cloud chart of the actual laser heat source under the condition where the laser power is 6 kW, the heat source radius is 0.6 mm, and the oscillating trajectory is circular (the oscillating amplitude is 2 mm, and the oscillating frequency is 40 Hz).

In FIG. 2, the chart on the left is a left view, in which the horizontal axis represents spatial positions perpendicular to the welding direction and the vertical axis represents the energy density of the heat source; the chart on the right is a right view, in which the horizontal axis represents spatial positions parallel to the welding direction and the vertical axis represents spatial positions perpendicular to the welding direction; the energy density of the area in a dark color is large, and the energy density in the area in a light color is small; and the oscillation of the laser beam in the welding process leads to non-uniform distribution of the energy density of different positions, resulting in peaks and valleys.

Step 2: extracting, from the energy distribution cloud chart, an energy distribution curve along the center of the heat source, selecting multiple target points of interest from the energy distribution curve, and determining spatial position information of the target points of interest;
Wherein, in one energy distribution cloud chart, only one energy distribution curve can be extracted along the center of the heat source, spatial position information of multiple target points of interest on the curve is extracted, and a Gaussian heat source model can be constructed according to the spatial information of each target point of interest. In this embodiment, the spatial position information of the target points of interest comprises point coordinates of two positions with a maximum energy density and point coordinates of a position with a minimum energy density in the energy distribution cloud chart. For example, in FIG. 2, the two positions with the maximum energy density are the positions of the two peaks, and the position with the minimum energy density of the position of the valley.

Step 3: constructing a corresponding equivalent Gaussian heat source model for each of the target points of interest according to the spatial position information of the target points of interest and features of the energy distribution curve, and determining a heat source power and a heat source radius of each Gaussian heat source model according to energy distribution of the actual laser welding heat source;
Wherein, the Gaussian heat source models are constructed according to the following expression:

$${q}_{i + 1} ( x , y , z ) = {A}_{i + 1} {f}_{i + 1} ( x , y , z )$$

Where, qᵢ₊₁(x,y,z) represents a heat flux density function of an i^{th} Gaussian heat source model, and x, y and z are coordinates of the i^{th} Gaussian heat source model in a space coordinate system, with an X-axis indicating a welding direction, a Y-axis indicating a direction perpendicular to the welding direction, and a Z-axis indicating a welding depth direction; Aᵢ₊₁ represents an energy coefficient of the i^{th} Gaussian heat source model,

$${A}_{i + 1} = \frac{6 {η}_{i + 1} {P}_{i + 1}}{π {r}_{i}^{2} {h}_{i + 1} ( {h}_{i + 1} + {r}_{i} )} ;$$

fᵢ₊₁(x,y,z) represents a shape function of the i^{th} Gaussian heat source model,

$${f}_{i + 1} = exp ( - \frac{3 {r}_{i}^{2}}{{R ( z )}^{2}} ) ;$$

hᵢ₊₁ represents an effective depth of the i^{th} Gaussian heat source model; r_{I} represents the heat source radius of the i^{th} Gaussian heat source model; ηᵢ₊₁ represents an effective power coefficient of the i^{th} Gaussian heat source model; Pᵢ₊₁ represents an actual power of the i^{th} Gaussian heat source model; R(z) represents a heat flux distribution function of the i^{th} Gaussian heat source model. The value of i may be determined by the fitting effect. For example, when the matching degrees do not satisfy a set threshold by superposing two Gaussian heat source models to replace the actual laser welding heat source, the positions of the Gaussian heat sources can be adjusted, and the value of i can also be changed to make an adjustment. In some embodiments, the value of i is identical with the number of the selected target points of interest; and when a desired fitting effect is fulfilled, the value of i may be less than the number of the selected target points of interest.

Step 4: verifying matching degrees between each Gaussian heat source model and the actual laser welding heat source, and taking Gaussian heat source models passing the verification as equivalent heat source models of the actual laser welding heat source;
Wherein, the matching degrees between each Gaussian heat source model and the actual laser welding heat source are verified by:
Constructing an energy distribution cloud chart of the Gaussian heat source model, comparing the Gaussian heat source model with the energy distribution cloud chart of the actual laser welding heat source in heat source effective range, point coordinates of positions with a maximum energy density, and point coordinates of positions with a minimum energy density to obtain a cloud chart matching degree;
Substituting the Gaussian heat source model into a welding simulation model to obtain heat field distribution in a welding process, and comparing the heat field distribution with an actual weld cross-sectional appearance to obtain a weld appearance matching degree; and
Determining that the Gaussian heat source model passes the verification only when the cloud chart matching degree and the weld appearance matching degree are both greater than a set matching degree threshold.

In this embodiment, the matching degree threshold may be set to 90%. During verification, if the matching degrees are less than the matching degree threshold, the heat source power and radius can be adjusted lightly to ensure the matching degrees of energy distribution.

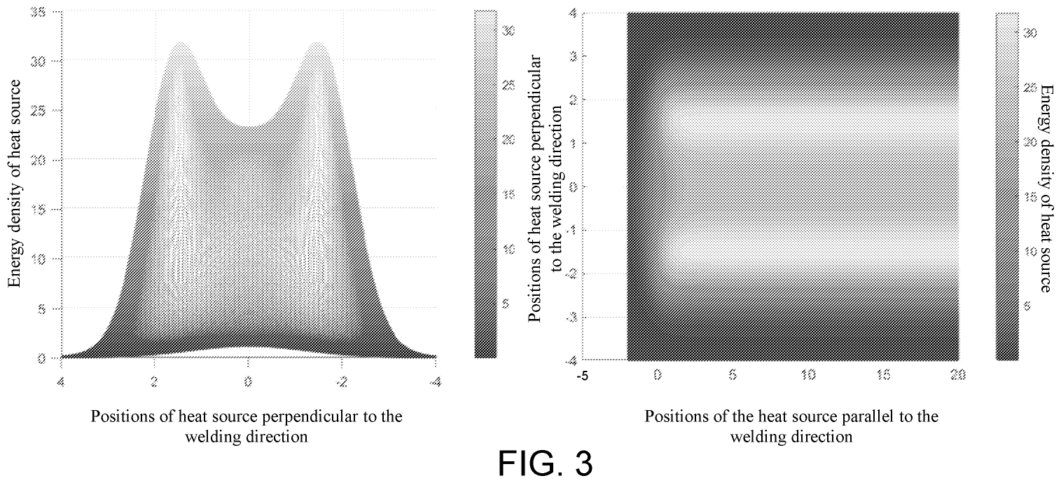

FIG. 3 illustrates an energy distribution cloud chart of the Gaussian heat source model constructed through the equivalent heat source modeling method for oscillating laser welding based on the energy distribution cloud chart shown in FIG. 2 according to an embodiment of the invention. It can be known, by comparing FIG. 2 and FIG. 3, that the energy distribution cloud chart of the Gaussian heat source model constructed through the equivalent heat source modeling method for oscillating laser welding provided by this embodiment highly matches the actual energy distribution cloud chart of oscillating laser welding, and slightly differs from the actual energy distribution cloud chart of oscillating laser welding merely at the beginning of welding and the end of welding, which can be ignored during the entire welding process simulation and analysis process.

Referring to FIG. 6 which illustrates a comparison diagram of the welding heat field distribution obtained after a constructed equivalent Gaussian heat source model is substituted into a welding simulation model with an actual weld cross-section according to an embodiment of the invention, the matching degree in welding appearance is high, indicating that the equivalent heat source model is effective. Generally speaking, when the energy distribution cloud chart of the equivalent heat source highly matches the actual energy distribution cloud chart of oscillating laser welding, the weld cross-section can also satisfy the threshold.

To sum up, according to the equivalent heat source modeling method for oscillating laser welding provided by this embodiment of the invention, by extracting the energy distribution curve along the center of the heat source from the energy distribution cloud chart, acquiring the spatial position information of multiple target points of interest, coupling the spatial position information according to the features of the energy distribution curve to construct equivalent Gaussian heat source models, energy distribution of an oscillating laser welding heat source is converted into coupled space energy of multiple heat sources; as commonly known, the oscillating welding heat source will oscillate periodically with time and will be located at different positions of the trajectory at different times, there is energy distribution information in the time dimension, and the use of equivalent heat sources converts the energy distribution with time into the superposition of several equivalent Gaussian heat sources, which have no oscillating trajectory, such that the energy distribution in the time dimension is converted into the superposition of multiple energy sources in the spatial dimension, thus simplifying the calculation process and realizing the construction of high-precision equivalent Gaussian heat source models of a laser welding heat source in different oscillating modes; the parameters of the equivalent Gaussian heat source models can reach the threshold without repeated adjustment, such that the heat source calibration cycle during oscillating laser welding simulation is greatly shortened, and the overall oscillating laser welding simulation efficiency is improved, accordingly.

### Embodiment 2

This embodiment provides a simulation method for oscillating laser welding comprising:
Constructing an equivalent heat source model through the equivalent heat source modeling method in Embodiment 1; and
Loading a to-be-welded workpiece model, and performing simulated welding on the to-be-welded workpiece model by means of the constructed equivalent heat source model to obtain welding simulation data.

The simulation method for oscillating laser welding provided by this embodiment of the invention adopts the equivalent heat source modeling method for oscillating laser welding in Embodiment 1, thus having corresponding beneficial effects of the equivalent heat source modeling method. Related technical details not described in this embodiment can be appreciated with reference to Embodiment 1. Because the simulation method adopts the equivalent heat source modeling method for oscillating laser welding in Embodiment 1, it can greatly shorten the heat source calibration cycle during oscillating laser welding simulation, thus improving the overall oscillating laser welding simulation efficiency.

### Embodiment 3

This embodiment of the invention provides an equivalent heat source modeling device for oscillating laser welding, comprising:

An energy distribution cloud chart construction module configured to construct an energy distribution cloud chart of an actual laser welding heat source to be modeled under different oscillating trajectories, oscillating frequencies and oscillating amplitudes according to heat source parameters of the actual laser welding heat source;
An extraction module configured to extract, from the energy distribution cloud chart, an energy distribution curve along the center of the heat source, select multiple target points of interest from the energy distribution curve, and determine spatial position information of the target points of interest;
An equivalent Gaussian heat source model construction module configured to construct a corresponding equivalent Gaussian heat source model for each of the target points of interest according to the spatial position information of the target points of interest and features of the energy distribution curve, and determine a heat source power and a heat source radius of each Gaussian heat source model according to energy distribution of the actual laser welding heat source; and
A verification module configured to verify matching degrees between each Gaussian heat source model and the actual laser welding heat source, and take Gaussian heat source models passing the verification as equivalent heat source models of the actual laser welding heat source.

The equivalent heat source modeling device for oscillating laser welding provided by this embodiment of the invention can implement the equivalent heat source modeling method for oscillating laser welding in Embodiment 1, and has corresponding beneficial effects of the equivalent heat source modeling method. Related technical details not described in this embodiment can be appreciated with reference to Embodiment 1, and will not be repeated here.

### Embodiment 4

This embodiment of the invention provides a simulation device for oscillating laser welding, comprising:
A modeling module configured to construct an equivalent heat source model through the equivalent heat source modeling method in Embodiment 1; and
A welding simulation module configured to load a to-be-welded workpiece model, and perform simulated welding on the to-be-welded workpiece model by means of the constructed equivalent heat source model to obtain welding simulation data.

The simulation device for oscillating laser welding provided by this embodiment can implement the simulation method for oscillating laser welding in Embodiment 2, and has corresponding beneficial effects of the simulation method. Related technical details not described in this embodiment can be appreciated with reference to Embodiment 2, and will not be repeated here.

The above embodiments are merely preferred ones of the invention. It should be pointed out that those skilled in the art can make some improvements and transformations without departing from the technical principle of the invention, and all these improvements and transformations should also fall within the protection scope of the invention.

1. An equivalent heat source modeling method for oscillating laser welding, comprising:
constructing, according to heat source parameters of an actual laser welding heat source to be modeled, an energy distribution cloud chart of the actual laser welding heat source in unit time under different oscillating trajectories, oscillating frequencies, oscillating amplitudes and oscillating speeds;
extracting, from the energy distribution cloud chart, an energy distribution curve along a center of the heat source;
selecting multiple target points of interest from the energy distribution curve, and determining spatial position information of the target points of interest;
constructing a corresponding equivalent Gaussian heat source model for each of the target points of interest according to the spatial position information of the target points of interest and features of the energy distribution curve, and determining a heat source power and a heat source radius of each said Gaussian heat source model according to energy distribution of the actual laser welding heat source; and
verifying matching degrees between each said Gaussian heat source model and the actual laser welding heat source, and taking Gaussian heat source models passing the verification as equivalent heat source models of the actual laser welding heat source.

2. The equivalent heat source modeling method for oscillating laser welding according to claim 1, wherein the actual laser welding heat source comprises one or more of a cylinder heat source, a cone heat source, a double-ellipsoid heat source and a surface heat source.

3. The equivalent heat source modeling method for oscillating laser welding according to claim 1, wherein the spatial position information of the target points of interest comprises point coordinates of two positions with a maximum energy density and point coordinates of a position with a minimum energy density in the energy distribution cloud chart.

4. The equivalent heat source modeling method for oscillating laser welding according to claim 1, wherein the heat source parameters comprise a heat source power, a heat source radius and a heat source center.

5. The equivalent heat source modeling method for oscillating laser welding according to claim 1, wherein verifying matching degrees between each said Gaussian heat source model and the actual laser welding heat source comprises:
constructing an energy distribution cloud chart of the Gaussian heat source model, comparing the Gaussian heat source model with the energy distribution cloud chart of the actual laser welding heat source in heat source effective range, point coordinates of positions with a maximum energy density, and point coordinates of positions with a minimum energy density to obtain a cloud chart matching degree;
substituting the Gaussian heat source model into a welding simulation model to obtain heat field distribution in a welding process, and comparing the heat field distribution with an actual weld cross-sectional appearance to obtain a weld appearance matching degree; and
determining that the Gaussian heat source model passes the verification only when the cloud chart matching degree and the weld appearance matching degree are both greater than a set matching degree threshold.

6. The equivalent heat source modeling method for oscillating laser welding according to claim 5, wherein the set matching degree threshold is 90%.

7. The equivalent heat source modeling method for oscillating laser welding according to claim 1, wherein the Gaussian heat source models constructed according to the following expression:
$${q}_{i + 1} ( x , y , z ) = {A}_{i + 1} {f}_{i + 1} ( x , y , z )$$
where, qᵢ₊₁(x,y,z) represents a heat flux density function of an i^{th} Gaussian heat source model, and x, y and z are coordinates of the i^{th} Gaussian heat source model in a space coordinate system, with an X-axis indicating a welding direction, a Y-axis indicating a direction perpendicular to the welding direction, and a Z-axis indicating a welding depth direction; Aᵢ₊₁ represents an energy coefficient of the i^{th} Gaussian heat source model,
$${A}_{i + 1} = \frac{6 {η}_{i + 1} {P}_{i + 1}}{π {r}_{i}^{2} {h}_{i + 1} ( {h}_{i + 1} + {r}_{i} )} ;$$
fᵢ₊₁(x,y,z) represents a shape function of the i^{th} Gaussian heat source model,
$${f}_{i + 1} = exp ( - \frac{3 {r}_{i}^{2}}{{R ( z )}^{2}} ) ;$$
hᵢ₊₁ represents an effective depth of the i^{th} Gaussian heat source model; r_{I} represents the heat source radius of the i^{th} Gaussian heat source model; ηᵢ₊₁ represents an effective power coefficient of the i^{th} Gaussian heat source model; Pᵢ₊₁ represents an actual power of the i^{th} Gaussian heat source model; R(z) represents a heat flux distribution function of the i^{th} Gaussian heat source model.

8. A simulation method for oscillating laser welding, comprising:
constructing an equivalent heat source model through the equivalent heat source modeling method according to claim 1; and
loading a to-be-welded workpiece model, and performing simulated welding on the to-be-welded workpiece model by means of the constructed equivalent heat source model to obtain welding simulation data.

9. An equivalent heat source modeling device for oscillating laser welding, comprising:
an energy distribution cloud chart construction module configured to construct an energy distribution cloud chart of an actual laser welding heat source to be modeled under different oscillating trajectories, oscillating frequencies and oscillating amplitudes according to heat source parameters of the actual laser welding heat source;
an extraction module configured to extract, from the energy distribution cloud chart, an energy distribution curve along a center of the heat source, select multiple target points of interest from the energy distribution curve, and determine spatial position information of the target points of interest;
an equivalent Gaussian heat source model construction module configured to construct a corresponding equivalent Gaussian heat source model for each of the target points of interest according to the spatial position information of the target points of interest and features of the energy distribution curve, and determine a heat source power and a heat source radius of each said Gaussian heat source model according to energy distribution of the actual laser welding heat source; and
a verification module configured to verify matching degrees between each said Gaussian heat source model and the actual laser welding heat source, and take Gaussian heat source models passing the verification as equivalent heat source models of the actual laser welding heat source.

10. A simulation device for oscillating laser welding, comprising:
a modeling module configured to construct an equivalent heat source model through the equivalent heat source modeling method according to claim 1; and
a welding simulation module configured to load a to-be-welded workpiece model, and perform simulated welding on the to-be-welded workpiece model by means of the constructed equivalent heat source model to obtain welding simulation data.
